(19) United States
(12) Patent Application Publication
(10) Pub. No.: US 2014/0340219 A1
(43) Pub. Date: Nov. 20, 2014

(54) PHYSIOLOGICAL MONITORING AND ALERTING

(71) Applicant: Zephyr Technology Corporation, Annapolis, MD (US)

(72) Inventors: BRIAN KEITH RUSSELL, Annapolis, MD (US); JONATHAN JAMES WOODWARD, Annapolis, MD (US); AMIT KUMAR MUKHERJEE, Elkridge, MD (US); DANIEL WAYNE BARTLETT, Annapolis, MD (US); BENJAMIN MORRIS, Washington, DC (US)

(73) Assignee: Zephyr Technology Corporation, Annapolis, MD (US)

(21) Appl. No.: 14/279,051

(22) Filed: May 15, 2014

Related U.S. Application Data
(60) Provisional application No. 61/823,596, filed on May 15, 2013.

(51) Int. Cl. G08B 21/02

(52) U.S. Cl. CPC G08B 21/02
USPC 340/539.12

(57) ABSTRACT

Methods, apparatuses and systems are described for monitoring physiological parameters by using one or more sensors at a person. First and second physiological parameters of the person are monitored. A determination may be made, at the one or more sensors, that at least one of the first and second physiological parameters has crossed a threshold. An alert event may be generated at the one or more sensors, based on the crossed thresholds. The alert event may then be transmitted to a computing device that is separate from the one or more sensors.

### CROSS-REFERENCE TO RELATED APPLICATIONS

This application claims priority to U.S. Provisional Patent Application No. 61/823,596, filed on May 15, 2013, the entirety of which is incorporated by reference herein.

### TECHNICAL FIELD

The present disclosure relates generally to physiological monitoring systems, and more particularly to remote physiological monitoring and alerting systems.

### BACKGROUND

Existing methods for remotely monitoring physiological parameters of a person typically include the use of cumbersome sensors and/or wires that may limit the effectiveness of measuring active individuals. Existing methods may also require the person to manually upload captured data. Remote monitoring systems that trigger alerts often are too sensitive and over-alert. Additionally, alerts that are triggered are not contextualized alerts. For example, although some known systems provide sensors operable for monitoring a person's vital signs “in the field,” these sensor systems may include multiple sensors interconnected by leads that make it uncomfortable for a mobile person. Further, known techniques may store the physiological data in a memory device associated with the sensors and then require the person to manually download the data to a personal computer. Finally, some known systems can generate alerts when the monitored physiological parameters exceed or fall below certain alarm limits. Such alerts, however, might only sound locally, and may typically only include an indication that the threshold has been crossed. The alert may thus be inadequate to allow a caregiver to properly respond to the alert. For example, a physiological sensor monitoring heart rate may trigger an alert if the person transitions from rest to physical activity because of the sudden, but expected, increase in the person's heart rate. Without contextualized data, it could be difficult to separate genuine emergencies from false alarms.

Accordingly, a need exists for systems and methods for physiological monitoring and alerting that are compact, unobtrusive, and which use low power consumption and which can limit the number of false alarms through the use of conditional alerting and/or can provide contextualized data that can provide greater insight into the cause and/or urgency of an alert.

### SUMMARY

The described features generally relate to one or more improved methods, systems, or apparatuses for remotely monitoring physiological parameters of a person and providing alerts regarding the same. The improved methods include using sensors located at the person to monitor one or more physiological parameters of the person. If at least one of the physiological parameters crosses a threshold, an alert event is generated at the sensors, and the sensors transmit the alert event to a computing device that is separate from the sensors.

As a result of the present disclosure, the reliability of remote monitoring and alerts based on the same can be improved. Alerts that are triggered based on both underlying parameter data and contextual data are more likely to be valid alerts. The provision of both underlying data and contextual data with an alert event to a monitoring care-giver can allow the care-giver to more thoroughly evaluate the validity of the received alert event. Further, the transmission of alert events and/or underlying and contextual data may occur at a frequency that is less than the actual detection frequency, meaning that sensor unit power and processing time may be improved.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example of a remote physiological parameter monitoring system;

FIG. 2 is a block diagram of an example of a sensor apparatus in accordance with various embodiments;

FIG. 3 is a block diagram of an example of a sensor apparatus in accordance with various embodiments;

FIG. 4 is a block diagram of an example of a sensor device in accordance with various embodiments;

FIG. 5 is a block diagram of an example of a server for communicating with a remote sensor device; and

FIGS. 6-11 are flowcharts of various methods for remote physiological monitoring and alerting, in accordance with various embodiments.

### DETAILED DESCRIPTION

Typically, remote monitoring of physiological parameters of a person involves cumbersome sensors and/or wires, person action to transmit stored data, and limited battery life of the remote sensors. Alert functions tend to be overly sensitive, in part due to a lack of contextual information to give meaning to the alert, both during generation of the alert as well as during evaluation. For these reasons, an improved remote physiological monitoring and alerting system, and method for using the same, is described herein. The remote monitoring and alerting system may include one or more wireless sensors that sense and process physiological parameters from a person. The processing performed at the sensors, including the determination of whether an alert event should be triggered, results in less data needing to be transmitted to a care-giver's monitoring station. Additionally, the use of contextual data to generate an alert event can reduce the instances of false alerts. The transmission of the contextual data with the alert event can enable a care-giver to properly evaluate the alert event. The contextual data and the data triggering the alert can be transmitted to the care-giver's monitoring station immediately or, if the transmission network is not available, the data may be transmitted as soon as the network is available.

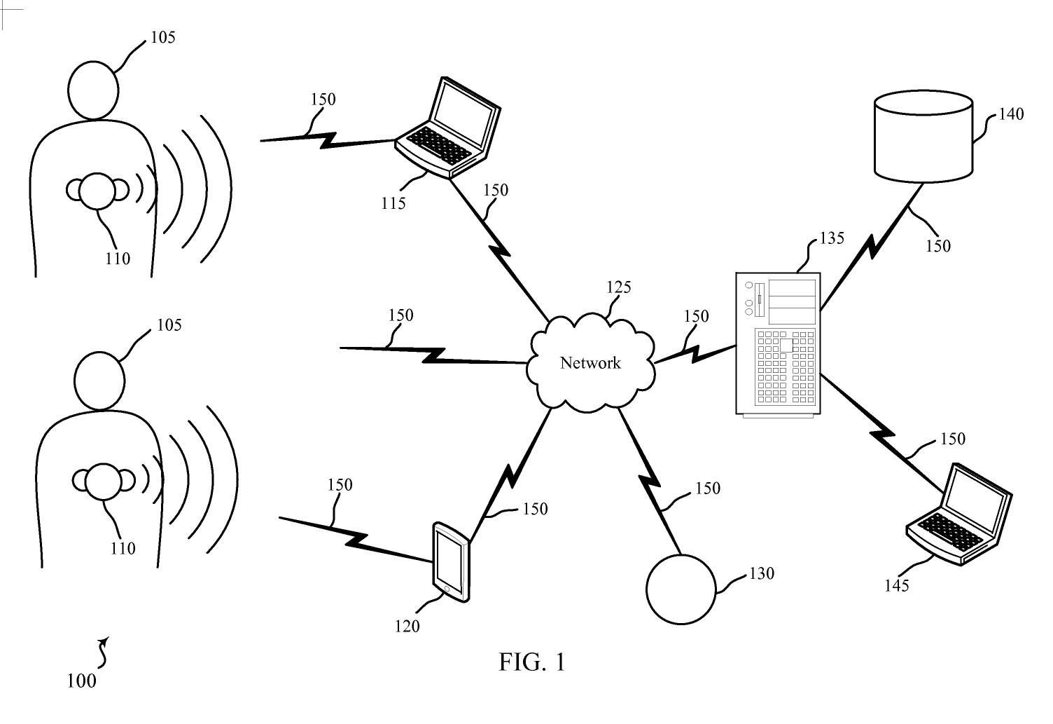

Referring first to FIG. 1, a diagram illustrates an example of a remote physiological parameter monitoring system 100. The system 100 includes persons 105, each wearing a sensor unit 110. The sensor units 110 transmit signals via wireless communication links 150. The transmitted signals may be transmitted to local computing devices 115, 120. Local computer device 115 may be a local care-giver's station, for example. Local computer device 120 may be a mobile device, for example. The local computing devices 115, 120 may be in communication with a server 135 via network 125. The sensor units 110 may also communicate directly with the server 135 via the network 125. Additional, third-party sensors 130 may also communicate directly with the server 135 via the network 125. The server 135 may be in further communication with a remote computer device 145, thus allowing a care-giver to remotely monitor the persons 105. The server 135 may also be in communication with various medical databases 140 where the collected data may be stored.

The sensor units 110 are described in greater detail below. Each sensor unit 110, however, is capable of sensing multiple physiological parameters. Thus, the sensor units 110 may each include multiple sensors such as heart rate and ECG sensors, respiratory rate sensors, and accelerometers. For example, a first sensor in a sensor unit 110 can be an accelerometer operable to detect a user's posture and/or activity level. In such an embodiment, the first sensor can be operable to determine whether the user is standing, sitting, laying down, and/or engaged in physical activity, such as running. A second sensor within a sensor unit 110 can be operable to detect a second physiological parameter. For example, the second sensor can be an electrocardiogram (ECG) sensing module, a breathing rate sensing module, and/or any other suitable module for monitoring any suitable physiological parameter. The data collected by the sensor units 110 may be wireless conveyed to either the local computer devices 115, 120 or to the remote computer device 145 (via the network 125 and server 135). Data transmission may occur via, for example, frequencies appropriate for a personal area network (such as Bluetooth or IR communications) or local or wide area network frequencies such as radio frequencies specified by the IEEE 802.15.4 standard. In some embodiments, the sensor units 110 may also include a human-readable display or a local alert function, and may include an LED, a haptic motor, a buzzer, etc. that may serve as a local alert.

The local computer devices 115, 120 may enable the person 105 and/or a local care-giver to monitor the collected physiological data. For example, the local computer devices 115, 120 may be operable to present data collected from sensor units 110 in a human-readable format. For example, the received data may be output as a display on a computer or a mobile device. The local computer devices 115, 120 may include a processor that may be operable to present data received from the sensor units 110, including alerts, in a visual format. The local computer devices 115, 120 may also output data and/or alerts in an audible format using, for example, a speaker.

The local computer devices 115, 120 can be custom computing entities configured to interact with the sensor units 110. In some embodiments, the local computer devices 115, 120 and the sensor units 110 may be portions of a single sensing unit operable to sense and display physiological parameters. In another embodiment, the local computer devices 115, 120 can be general purpose computing entities such as a personal computing device, such as a desktop computer, a laptop computer, a netbook, a tablet personal computer (PC), an iPod®, an iPad®, a smart phone (e.g., an iPhone®, an Android® phone, a Blackberry®, a Windows® phone, etc.), a mobile phone, a personal digital assistant (PDA), and/or any other suitable device operable to send and receive signals, store and retrieve data, and/or execute modules.

The local computer devices 115, 120 may include memory, a processor, an output, and a communication module. The processor can be a general purpose processor, a Field Programmable Gate Array (FPGA), an Application Specific Integrated Circuit (ASIC), a Digital Signal Processor (DSP), and/or the like. The processor can be configured to retrieve data from and/or write data to the memory. The memory can be, for example, a random access memory (RAM), a memory buffer, a hard drive, a database, an erasable programmable read only memory (EPROM), an electrically erasable programmable read only memory (EEPROM), a read only memory (ROM), a flash memory, a hard disk, a floppy disk, cloud storage, and/or so forth. In some embodiments, the local computer devices 115, 120 can include one or more hardware-based modules (e.g., DSP, FPGA, ASIC) and/or software-based modules (e.g., a module of computer code stored at the memory and executed at the processor, a set of processor-readable instructions that can be stored at the memory and executed at the processor) associated with executing an application, such as, for example, receiving and displaying data from sensor units 110.

The processor of the local computer devices 115, 120 may be operated to control operation of the output of the local computer devices 115, 120. The output can be a television, a liquid crystal display (LCD) monitor, a cathode ray tube (CRT) monitor, speaker, tactile output device, and/or the like. In some embodiments, the output may be used as a local alert function, and may include an LED, a haptic motor, a buzzer, etc. In some embodiments, the output can be an integral component of the local computer devices 115, 120. Similarly stated, the output can be directly coupled to the processor. For example, the output can be the integral display of a tablet and/or smart phone. In some embodiments, an output module can include, for example, a High Definition Multimedia Interface™ (HDMI) connector, a Video Graphics Array (VGA) connector, a Universal Serial Bus™ (USB) connector, a tip, ring, sleeve (TRS) connector, and/or any other suitable connector operable to couple the local computer devices 115, 120 to the output.

As described in additional detail herein, at least one of the sensor units 110 can be operable to transmit physiological data to the local computer devices 115, 120 and/or to the remote computer device 145 continuously, at scheduled intervals, when requested, and/or when certain conditions are satisfied (e.g., during an alarm condition).

The remote computer device 145 can be a computing entity operable to enable a remote user to monitor the output of the sensor units 110. The remote computer device 145 can be functionally and/or structurally similar to the local computer devices 115, 120 and can be operable to receive and/or send signals to at least one of the sensor units 110 via the network 125. The network 125 can be the Internet, an intranet, a personal area network, a local area network (LAN), a wide area network (WAN), a virtual network, a telecommunications network implemented as a wired network and/or wireless network, etc. The remote computer device 145 can receive and/or send signals over the network 125 via communication links 150.

The remote computer device 145 can be used by, for example, a health care professional to monitor the output of the sensor units 110. In some embodiments, as described in further detail herein, the remote computer device 145 can receive an indication of physiological data when the sensors detect an alert condition, when the healthcare provider requests the information, at scheduled intervals, and/or at the request of the healthcare provider and/or the person 105.

The server 135 may be configured to communicate with the sensor units 110, the local computer devices 115, 120, third-party sensors 130, the remote computer device 145 and databases 140. The server 135 may perform additional processing on signals received from the sensor units 110, local computer devices 115, 120 or third-party sensors 130, or may simply forward the received information to the remote computer device 145 and databases 140. The databases 140 may be examples of electronic health records (“EHRs”) and/or personal health records (“PHRs”), and may be provided by various service providers. The third-party sensor 130 may be a sensor that is not attached to the person 105 but that still provides data that may be useful in connection with the data provided by sensor units 110.

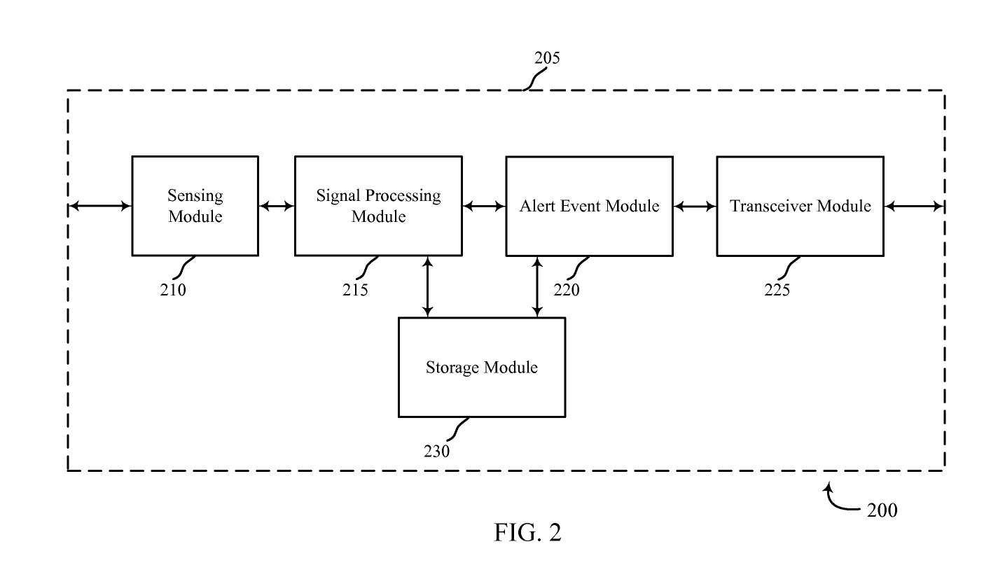

FIG. 2 is an example of a block diagram 200 of an apparatus 205 that may be used for sensing and reporting physiological parameters, in accordance with various aspects of the present disclosure. In some examples, the apparatus 205 may be an example of aspects of one or more of the sensor units 110 described with reference to FIG. 1, and may sense and transmit both physiological data as well as alerts regarding the same. The apparatus 205 may also be a processor. The apparatus 205 may include a sensing module 210, a signal processing module 215, an alert event module 220, a transceiver module 225, and/or a storage module 230. Each of these components may be in communication with each other.

The components of the apparatus 205 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

In some examples, the sensing module 210 may include at least one sensor. Alternatively, the apparatus 205 may include multiple sensing modules 210, each associated with at least one sensor. For example, a first sensor may be operable to detect a first physiological parameter via a first sensing module. A second sensor may be operable to detect a second physiological parameter via either a second sensing module or the first sensing module. As additional examples, the sensing module 210 can include an accelerometer operable to detect a person's posture and/or activity level. Thus, the sensing module 210 may be operable to determine whether the person is standing, sitting, laying down, and/or engaged in physical activity, such as running. The sensing module 210 may also be operable to detect a second physiological parameter. For example, the sensing module 210 may further include an electrocardiogram (ECG) sensing module, a breathing rate sensing module, and/or any other suitable module for monitoring any suitable physiological parameter.

In some examples, the signal processing module 215 includes circuitry, logic, hardware and/or software for processing the signals output by the sensing module 210. The signal processing module 215 may include filters, analog-to-digital converters and other digital signal processing units. Data processed by the signal processing module 215 may be stored in a buffer, for example, in the storage module 230. The storage module 230 may include magnetic, optical or solid-state memory options for storing data processed by the signal processing module 215.

In some examples, the transceiver module 225 may be operable to send and/or receive signals between the sensor units 110 and either the local computer devices 115, 120 or the remote computer device 145 via the network 125 and server 135. In an embodiment, the transceiver module 225 may receive data from other sensor units 110 or apparatuses 205 and may then transmit the data collected from multiple sensor units 110 or apparatuses 205 to either the local computer devices 115, 120 or the remote computer device 145. The transceiver module 225 can include wired and/or wireless connectors. For example, in some embodiments, sensor units 110 can be portions of a wired or wireless sensor network, coupled by the transceiver module 225. The transceiver module 225 can be a wireless network interface controller (“NIC”), Bluetooth® controller, IR communication controller, ZigBee® controller and/or the like.

In some examples, the alert event module 220 may be used to manage the determination and transmission of one or more alert events based on the physiological parameters monitored by the sensing module 210. The alert event module 220 may coordinate transmission of the alert events via the transceiver module 225. The alert event module 220 may also communicate with the storage module 230 to store and retrieve alert events as well as associated data. Additionally, the alert event module 220 may further communicate with the transmitter module 225 to transmit the alert events and associated data to a different apparatus (e.g., another apparatus 205) for storage on that apparatus's storage module.

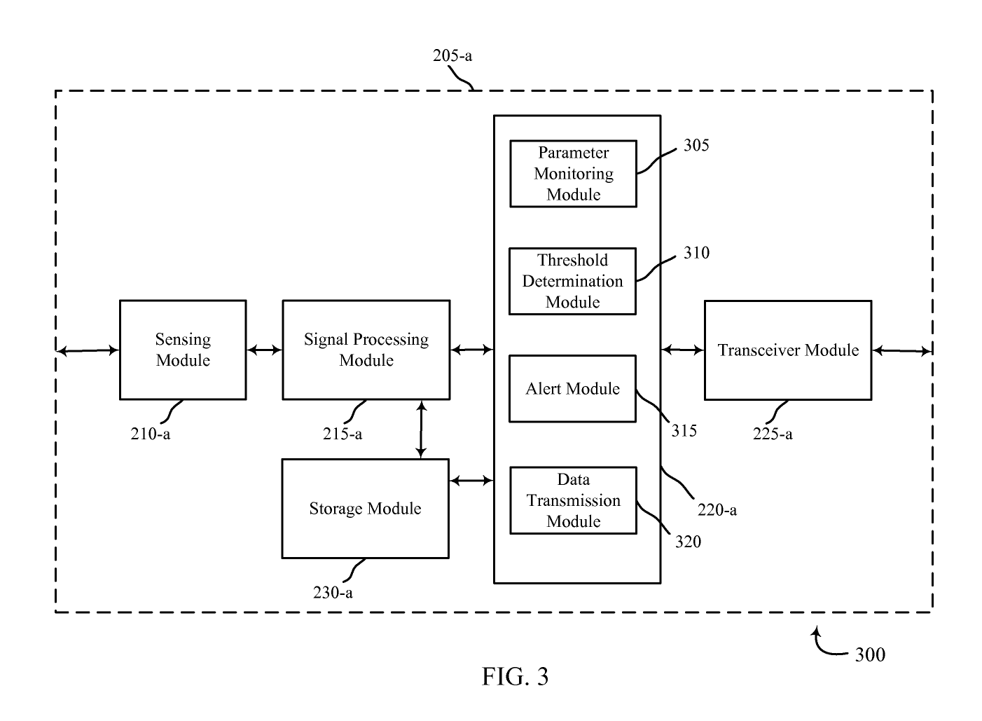

FIG. 3 shows a block diagram 300 that includes apparatus 205-a, which may be an example of one or more aspects of the apparatus 205 (of FIG. 2) for use in remote physiological monitoring, in accordance with various aspects of the present disclosure. In some examples, the apparatus 205-a may include a sensing module 210-a, a signal processing module 215-a, a storage module 230-a, and a transceiver module 225-a, which may be examples of the sensing module 210, the signal processing module 215, the storage module 230 and transceiver module 225 of FIG. 2. In additional examples, the apparatus 205-a may include an alert event module 220-a, which may be an example of one or more aspects of the alert event module 220 of FIG. 2. In some examples, the alert event module 220-a may include a parameter monitoring module 305, a threshold determination module 310, an alert module 315 and/or a data transmission module 320. The modules 305, 310, 315 and/or 320 may each be used in aspects of determining and reporting alert events, as described below. While FIG. 3 illustrates a specific example, the functions performed by each of the modules 305, 310, 315 and/or 320 may be combined or implemented in one or more other modules.

The parameter monitoring module 305 may be used to monitor the various parameters being sensed via the sensing module 210-a. For example, if the sensing module 210-a is sensing heart rate information, the parameter monitoring module 305 is configured to monitor the sensed heart rate information. In particular, the parameter monitoring module 305 is configured to identify any potential conditions that may trigger an alert event. In some cases, a high heart rate (as indicated by the heart rate being more than a threshold, as explained below) may be identified as a condition that could trigger an alert event. A sudden increase or drop in heart rate could be a condition that could trigger an alert event. Additionally, combinations of conditions may trigger an alert event. Thus, the parameter monitoring module 305 monitors multiple physiological parameters (e.g., heart rate, respiratory rate, posture and/or activity level). The parameter monitoring module 305 may monitor both processed physiological parameters and unprocessed (or “raw”) physiological parameters. The parameter monitoring module 305 may monitor any other parameters sensed via the sensing module 210-a, including, but not limited to, environmental parameters sensed via the sensing module 210-a. Any of the parameters monitored by the parameter monitoring module 305 may, either individually or in combination, trigger an alert event.

The threshold determination module 310 may be used to determine thresholds that could trigger an alert event. Some thresholds may be preconfigured. Some thresholds may also be received or updated through configuration commands received by the apparatus 205-a during either a locally- or remotely-applied update. Some thresholds may be selected based on the monitored conditions. For example, a preconfigured threshold for one measured parameter may be based on a value of a second measured parameter. Thus, a threshold relating to a person's heart rate may be influenced by sensed information relating to the person's activity level or posture. A determined threshold for the person's heart rate may be different depending on whether the person is sleeping (with a low activity level) or running (with a high activity level). Therefore, the threshold determination module 310 uses the information monitored by the parameter monitoring module 305 and determines, based on one or more of the monitored parameters, which thresholds should be applied. The thresholds to-be-applied may be selected from a table or other stored reference, or may be determined in connection with an algorithm.

The alert module 315 may be used to determine whether an alert event should be triggered based on the values of the parameters being monitored by the parameter monitoring module 305 and the values of the thresholds determined by the threshold determination module 310. The alert module 315 may trigger alerts based on a single monitored parameter crossing a determined threshold or threshold zone, or may trigger alerts based on a combination of parameters crossing thresholds or threshold zones. Additionally, the alert module 315 may trigger alerts based on a change in a value of one or more parameters, where the change exceeded a threshold. Further, the alert module 315 may trigger alerts based on a threshold or other condition being exceeded or met for a predetermined period of time.

In this way, the alert module 315 can determine whether to trigger an alert event by not just considering the values of the parameter associated with the alert event, but by also considering contextual information, as provided by other monitored parameters. Thus, and for example, an alert based on a monitored heart rate parameter may be based on contextual information relating to the person's posture and/or activity level.

The data transmission module 320 can determine what data should be transmitted to a local computer device 115, 120 or a remote computer device 145 (of FIG. 1) via the transceiver module 225-a. If the alert module 315 has determined that an alert event should be triggered, the data transmission module 320 may transmit the determined alert event. Along with the alert event, the data transmission module 320 may also transmit additional data that may be related to the alert event, so as to enable a care-giver monitoring either the local computer devices 115, 120 or the remote computer device 145 to assess the alert event using additional information regarding the alert event. For example, the data transmission module 320 may send a segment of data (either processed or unprocessed) corresponding to the parameter for which the alert was triggered. The data to-be-transmitted may include data collected from before the triggering of the alert event as well as data collected after the triggering of the alert event. Additionally, the data to-be-transmitted may also include contextual data, also collected from before the triggering of the alert event and/or after the alert event is triggered.

Additionally, the data transmission module 320 may control the frequency of the data that is transmitted from the apparatus 205-a. For example, when the apparatus 205-a first begins to sense physiological parameters, the apparatus 205-a may transmit data at a high frequency. Sensed data could be transmitted continuously or at, for example, one-minute intervals. However, after the apparatus 205-a is operated for a period of time, the rate of data transmission may decrease to a slower rate (for example, every fifteen minutes). Despite the decreased transmission schedule, data may also be transmitted whenever an alert event is triggered. Alternatively, data could be transmitted only when an alert event is triggered. Further, the frequency of data transfer may be much less than the sampling rate of the physiological parameters. Each monitored parameter may be monitored and/or sampled at a different rate. However, the transmission rate may be slower than the monitored rate.

The data transmission module 320 also determines that if data is ready to be transmitted and no network connection exists (via the transceiver module 225-a), the data to be transmitted is instead stored and held until transmission can occur (e.g., the network connection is restored).

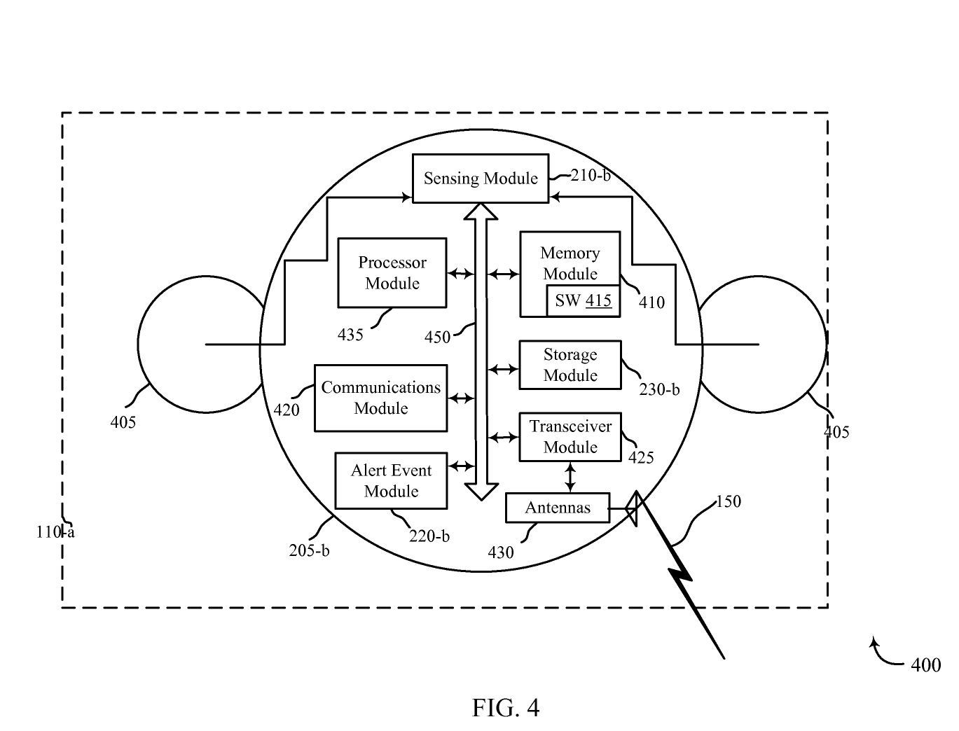

FIG. 4 shows a block diagram 400 of a sensor unit 110-a for use in remote physiological monitoring, in accordance with various aspects of the present disclosure. The sensor unit 110-a may have various configurations. The sensor unit 110-a may, in some examples, have an internal power supply (not shown), such as a small battery, to facilitate mobile operation. In some examples, the sensor unit 110-a may be an example of one or more aspects of one of the sensor units 110 and/or apparatus 205 described with reference to FIGS. 1, 2 and/or 3. The sensor unit 110-a may be configured to implement at least some of the features and functions described with reference to FIGS. 1, 2 and/or 3.

The sensor unit 110-a may include one or more electrodes 405 and a sensing apparatus 205-b. The sensing apparatus 205-b may further include a sensing module 210-b, a processing module 435, a memory module 410, a communications module 420, at least one transceiver module 425, at least one antenna (represented by antennas 430), a storage module 230-b, or an alert event module 220-b. Each of these components may be in communication with each other, directly or indirectly, over one or more buses 450. The sensing module 210-b and the storage module 230-b may be examples of the sensing module 210 and storage module 230, respectively, of FIGS. 2 and 3.

The memory module 410 may include random access memory (RAM) or read-only memory (ROM). The memory module 410 may store computer-readable, computer-executable software (SW) code 415 containing instructions that are configured to, when executed, cause the processor module 435 to perform various functions described herein for communicating, for example, alert events. Alternatively, the software code 415 may not be directly executable by the processor module 435 but be configured to cause the sensor unit 110-a (e.g., when compiled and executed) to perform various of the functions described herein.

The processor module 435 may include an intelligent hardware device, e.g., a CPU, a microcontroller, an ASIC, etc. The processor module 435 may process information received through the transceiver module 425 or information to be sent to the transceiver module 425 for transmission through the antenna 430. The processor module 435 may handle, alone or in connection with the alert event module 220-b, various aspects of signal processing as well as determining and transmitting alert events.

The transceiver module 425 may include a modem configured to modulate packets and provide the modulated packets to the antennas 430 for transmission, and to demodulate packets received from the antennas 430. The transceiver module 425 may, in some examples, be implemented as one or more transmitter modules and one or more separate receiver modules. The transceiver module 425 may support alert event-related communications. The transceiver module 425 may be configured to communicate bi-directionally, via the antennas 435 and communication link 150, with, for example, local computer devices 115, 120 and/or the remote computer device 145 (via network 125 and server 135 of FIG. 1). Communications through the transceiver module 425 may be coordinated, at least in part, by the communications module 420. While the sensor unit 110-a may include a single antenna, there may be examples in which the sensor unit 110-a may include multiple antennas 430.

The alert event module 220-b may be configured to perform or control some or all of the features or functions described with reference to FIGS. 1, 2 and/or 3 related to alert event generation and transmission. For example, the alert event module 220-b may be configured to monitor the physiological parameters sensed by the sensing module 210-b. In some examples, the alert event module 220-b may determine threshold levels, where the determined threshold levels may be based, at least in part, on the monitored physiological parameters. The alert event module 220-b may determine that alert events should be triggered, based on the monitored physiological parameters and the determined thresholds. The alert events and associated physiological data (both the data, either processed or unprocessed, to which the alert pertains as well as contextual data) may be transmitted to either a local computer device 115, 120 or a remote computer device 145. The alert event module 220-b may be an example of one or more aspects of the alert event module 220 described with reference to FIGS. 2 and 3. The alert event module 220-b, or portions of it, may include a processor, or some or all of the functions of the alert event module 220-b may be performed by the processor module 435 or in connection with the processor module 435. Additionally, the alert event module 220-b, or portions of it, may include a memory, or some or all of the functions of the alert event module 220-b may use the memory module 410 or be used in connection with the memory module 410.

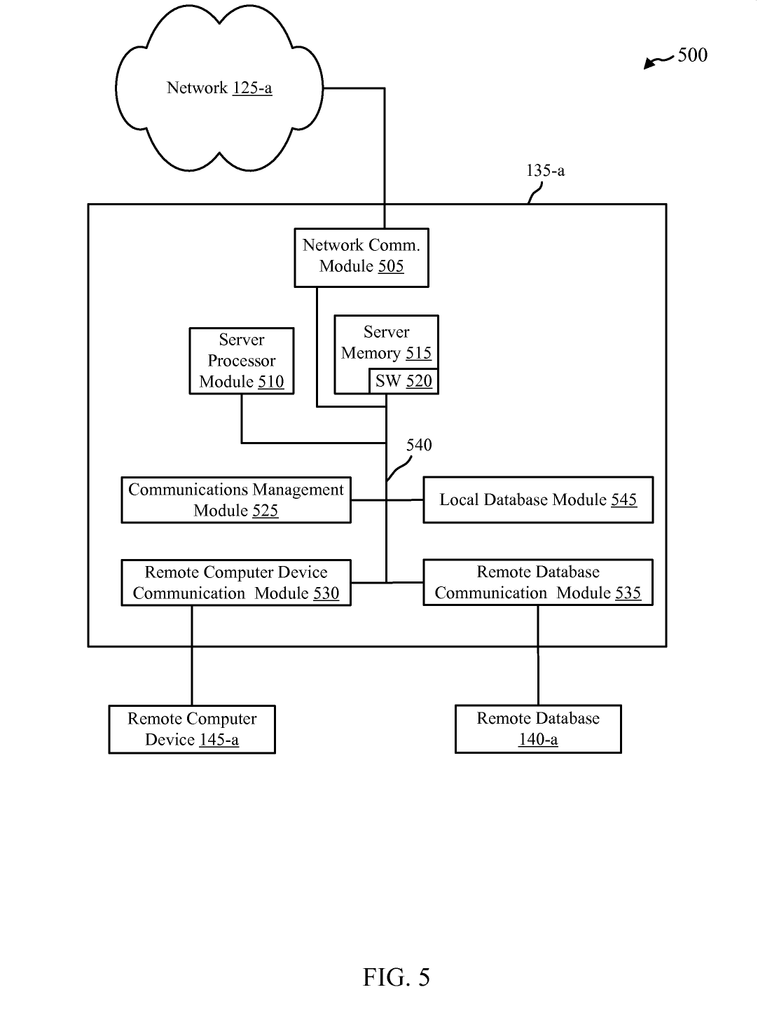

FIG. 5 shows a block diagram 500 of a server 135-a for use in remote physiological monitoring, in accordance with various aspects of the present disclosure. In some examples, the server 135-a may be an example of aspects of the server 135 described with reference to FIG. 1. The server 135-a may be configured to implement or facilitate at least some of the server features and functions described with reference to FIG. 1.

The server 135-a may include a server processor module 510, a server memory module 515, a local database module 545, and/or a communications management module 525. The server 135-a may also include one or more of a network communication module 505, a remote computer device communication module 530, and/or a remote database communication module 535. Each of these components may be in communication with each other, directly or indirectly, over one or more buses 540.

The server memory module 515 may include RAM and/or ROM. The server memory module 515 may store computer-readable, computer-executable code 520 containing instructions that are configured to, when executed, cause the server processor module 510 to perform various functions described herein related to remote physiological monitoring. Alternatively, the code 520 may not be directly executable by the server processor module 510 but be configured to cause the server 135-a (e.g., when compiled and executed) to perform various of the functions described herein.

The server processor module 510 may include an intelligent hardware device, e.g., a central processing unit (CPU), a microcontroller, an ASIC, etc. The server processor module 510 may process information received through the one or more communication modules 505, 530, 535. The server processor module 510 may also process information to be sent to the one or more communication modules 505, 530, 535 for transmission. Communications received at or transmitted from the network communication module 505 may be received from or transmitted to sensor units 110, local computer devices 115, 120, or third-party sensors 130 via network 125-a, which may be an example of the network 125 described in relation to FIG. 1. Communications received at or transmitted from the remote computer device communication module 530 may be received from or transmitted to remote computer device 145-a, which may be an example of the remote computer device 145 described in relation to FIG. 1. Communications received at or transmitted from the remote database communication module 535 may be received from or transmitted to remote database 140-a, which may be an example of the remote database 125 described in relation to FIG. 1. Additionally, a local database may be accessed and stored at the server 135-a. The local database module 545 is used to access and manage the local database, which may include data received from the sensor units 110, the local computer devices 115, 120, the remote computer devices 145 or the third-party sensors 130 (of FIG. 1).

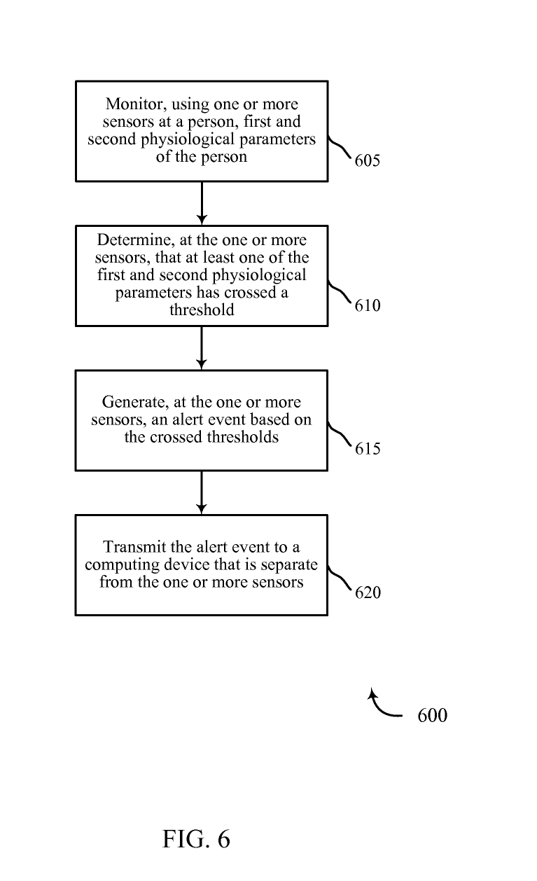

FIG. 6 is a flow chart illustrating an example of a method 600 for remote physiological monitoring, in accordance with various aspects of the present disclosure. For clarity, the method 600 is described below with reference to aspects of one or more of the sensor units 110 described with reference to FIGS. 1 and/or 4, respectively, or aspects of one or more of the apparatus 205 described with reference to FIGS. 2 and/or 3. In some examples, a sensor unit such as one of the sensor units 110 or an apparatus such as one of the apparatuses 205 may execute one or more sets of codes to control the functional elements of the sensor unit or apparatus to perform the functions described below.

At block 605, the method 600 may include monitoring, using one or more sensors at a person, first and second physiological parameters of the person. The first and second physiological parameters could be, for example, a heart rate and an activity level, respectively.

At block 610, the method 600 may include determining, at the one or more sensors, that at least one of the first and second physiological parameters has crossed a threshold. For example, a determination may be made that a monitored heart rate parameter had exceeded a threshold. Alternatively, a determination may be made that both a monitored heart rate parameter and a monitored activity level parameter had exceeded thresholds. The one or more monitored parameters may have changed, and the change may have been in excess of a threshold. Alternatively, a determination may be made that one or more of the monitored parameters exceeded a threshold for at least a predetermined period of time.

At block 615, the method 600 may include generating, at the one or more sensors, an alert event based on the crossed thresholds. The alert event may be related to one of the monitored physiological parameters, while other monitored physiological parameters may provide context for the alert event.

At block 620, the method 600 may include transmitting the alert event to a computing device that is separate from the one or more sensors. The transmission may be to a local computer device, a server, or a remote computer device, for example.

In some embodiments, the operations at blocks 605, 610, 615 or 620 may be performed using the alert event module 220 described with reference to FIGS. 2, 3 and/or 4. Nevertheless, it should be noted that the method 600 is just one implementation and that the operations of the method 600 may be rearranged or otherwise modified such that other implementations are possible.

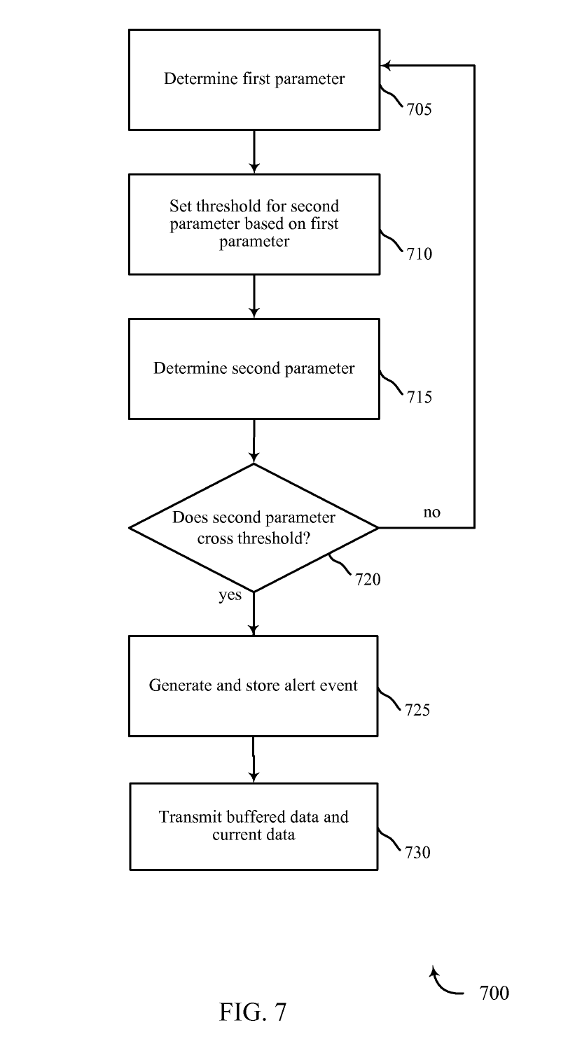

FIG. 7 is a flow chart illustrating an example of a method 700 for remote physiological monitoring, in accordance with various aspects of the present disclosure. For clarity, the method 700 is described below with reference to aspects of one or more of the sensor units 110 described with reference to FIGS. 1 and/or 4, respectively, or aspects of one or more of the apparatus 205 described with reference to FIGS. 2 and/or 3. In some examples, a sensor unit such as one of the sensor units 110 or an apparatus such as one of the apparatuses 205 may execute one or more sets of codes to control the functional elements of the sensor unit or apparatus to perform the functions described below.

The sensor unit may include one or more sensors for determining a physiological parameter. For example, the sensor unit may include a posture sensor (which may include an accelerometer, a gyroscope, a piezoelectric sensor, a strain gage, etc.) and a heart rate sensor (such as an ECG sensor). In method 700, block 705 includes determining a first parameter type, such as a posture type. In the example, the posture sensor can be operable to determine whether the user is laying down, sitting, standing, slouching, and/or an activity level, such as sleeping, walking, running, etc. The posture sensor may be operable to determine the orientation of the posture sensor and/or acceleration data and associate this information with a posture or activity level of a person.

At block 710, a threshold for a second parameter is set based on the first parameter. Thus, for example, a heart rate threshold, envelope, and/or alarm and/or reporting condition can be set based on the posture type determined at block 705. The posture of the user can determine how the sensor system evaluates heart rate data. For example, if the posture sensor indicates that the user is laying down, a heart rate alarm and/or reporting threshold can be set to a relatively low threshold (for example, approximately 100 beats per minute (bpm)); but if the posture sensor indicates that the user is standing, the threshold can be set to a higher threshold (for example, approximately 120 bpm). If the posture sensor indicates the user is running, an upper threshold can be set (for example, of approximately 140 bpm) while a lower threshold can also be set (at, for example, approximately 70 bpm). In some embodiments the threshold can be preset. In other embodiments, the thresholds can be customized for the user. In some embodiments, the thresholds can be based on historical heart rate data of the user or other historical data.

In this way, a two-factor alarm can cause the sensor system to alert based on both posture and heart rate. Because heart rate changes with posture and exertion, a heart rate threshold based on the user's at-rest heart rate may cause false alarms when the user transitions from resting to exercise. By relating the heart rate threshold to a posture, these false alarms can be reduced or eliminated.

In some embodiments, setting the threshold for a second parameter based on the value of a first parameter (as at block 710), can include ramping and/or delaying setting the thresholds based on transitions between types of a parameter (for example, of posture types). For example, if the user transitions from running to laying, the upper heart rate threshold can be decreased from an active threshold state (e.g., approximately 140 bpm) to an at-rest threshold state (e.g., approximately 100 bpm) over an approximately 30 minute period. In this way, the sensor system can avoid false alarms triggered by sudden changes in alarm limits.

At block 715, the value of a second parameter may be determined. For example, the person's heart rate may be determined. The value of the second parameter may be compared with the determined threshold (at block 720). If the value of the second parameter crosses the threshold or a threshold zone, then an alert event may be generated (at block 725). If the value of the second parameter does not cross the threshold or zone, then the method 700 returns to block 705.

For example, a heart rate sensor can be operable to determine the user's heart rate as the second determined parameter. The heart rate can be compared to the threshold, at block 720. If the heart rate is within the heart rate threshold, the sensing system can continue to monitor posture and heart rate. If the heart rate crosses the threshold or threshold zone, however, an alert can be generated and/or stored, at block 725. For example, the sensor system can send a notification to a local computer device and/or a remote computer device as described above with reference to FIG. 1. The notification can be operable to cause the local computer device and/or the remote computer device to alert the user and/or a healthcare provider that the threshold or zone has been crossed.

The sensor unit can send contextualized data and alerts to the local computer device and/or the remote compute device, at block 730. For example, the contextualized heart rate and/or posture data may be transmitted. The sensor unit can buffer heart rate and/or posture data as it is received, and, when a threshold or threshold zone is crossed, the system can send the data stored in the buffer such that the person and/or the healthcare provider can examine the data leading up to the threshold or threshold zone crossing. For example, the sensor unit can be operable to send posture and/or heart rate data (or other physiological parameters), at block 730, for 5 s, 10 s, 15 s, 30 s, 1 min, 5 min, and/or any other suitable length of time before and/or after the heart rate crosses the threshold or threshold zone, at block 720. Contextualized data can aid the person and/or the healthcare provider in evaluating the alarm. For example, if the threshold or threshold zone crossing was a sudden spike that quickly reverted to the previous value, it can be indicative of a false alarm. Similarly, in the event of a cardiac emergency, heart rate and/or posture data preceding the event can aid a healthcare provider in assessing the severity of the emergency, in diagnosing the cause of the emergency, and/or provide useful information to aid the person in avoiding future emergencies.

In some embodiments, the alert can be generated locally, at block 725, before the data is transmitted, at block 730. Alerting locally, at block 725, can allow the user to override the transmission, at block 730, for example, by indicating that the alert is not an emergency—that the alert is a false alarm, that the condition that caused the alert is under control, etc. For example, an override button can be provided which can be operable to prevent a monitoring system from transmitting data.

In some embodiments, the operations at blocks 705, 710, 715, 720, 725 or 730 may be performed using the alert event module 220 described with reference to FIGS. 2, 3 and/or 4. Nevertheless, it should be noted that the method 700 is just one implementation and that the operations of the method 700 may be rearranged or otherwise modified such that other implementations are possible.

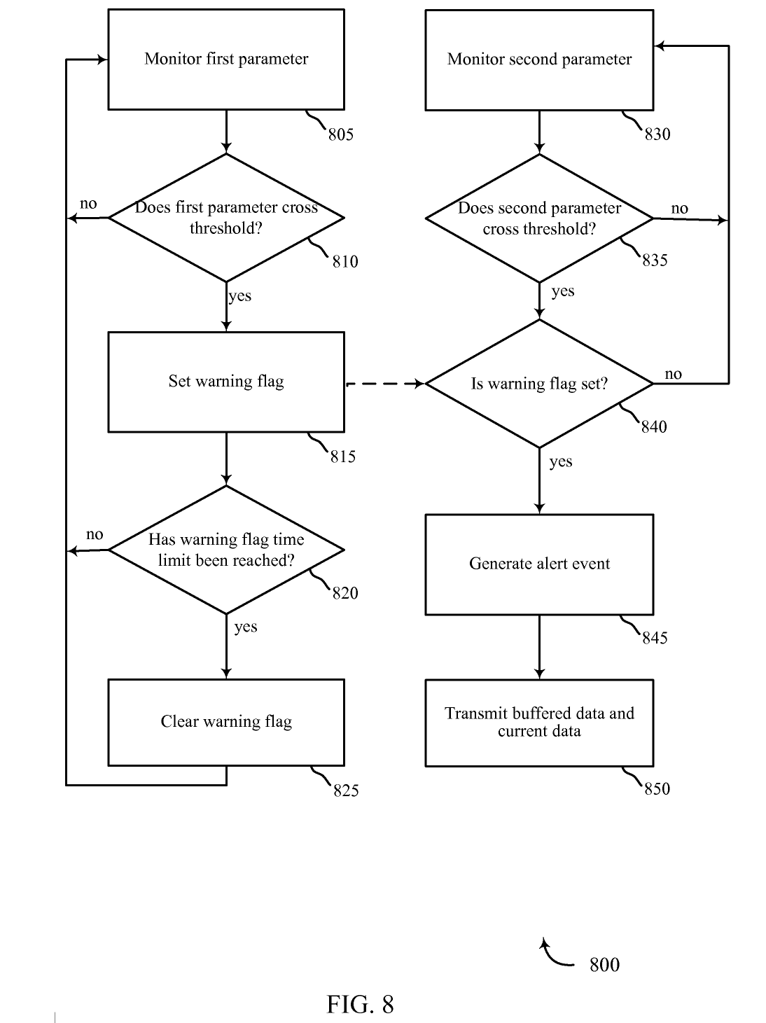

FIG. 8 is a flow chart illustrating an example of a method 800 for remote physiological monitoring, in accordance with various aspects of the present disclosure. For clarity, the method 800 is described below with reference to aspects of one or more of the sensor units 110 described with reference to FIGS. 1 and/or 4, respectively, or aspects of one or more of the apparatus 205 described with reference to FIGS. 2 and/or 3. In some examples, a sensor unit such as one of the sensor units 110 or an apparatus such as one of the apparatuses 205 may execute one or more sets of codes to control the functional elements of the sensor unit or apparatus to perform the functions described below.

In method 800, a first parameter and a second parameter can be monitored, at blocks 805 and 830, respectively. Monitoring the first parameter and the second parameter can include monitoring physiological data, such as posture, heart rate, breathing rate, perspiration, blood pressure, body temperature, etc. In some embodiments, the first parameter can be monitored with a first sensor within a sensor unit 110 while the second parameter can be monitored with a second sensor within the sensor unit 110.

Thresholds and/or alarm limits can be associated with the first parameter and the second parameter. For example, upper and lower bounds can be associated with each parameter. The thresholds can be set such that a departure from typical physiological conditions will cause a threshold to be crossed. In some embodiments, the thresholds can be pre-set based on typical physiological constraints and/or personalized physiological ranges. Pre-set thresholds can be based on physical characteristics of the user, such as age, sex, health, fitness, etc. The thresholds can be based on statistically collected data for a population of which the user is a member. In other embodiments, the thresholds can be unique for each user. For example, the thresholds can be dynamically set based on recent physiological data and/or individualized analysis of the user's physiological parameters.

The first parameter thresholds can be set based on the second parameter (e.g., as shown and described with reference to method 700 of FIG. 7). For example, a heart rate threshold may be set based on posture type. The first and second parameters monitored, at blocks 805 and 830, respectively, can be compared to the first and second thresholds, at blocks 810 and 835, respectively. If the first parameter does not cross the first threshold, at block 810, the method can include continuing to monitor the first parameter, at block 805. Similarly, if the second parameter does not cross the second threshold, at block 835, the method can include continuing to monitor the second parameter, at block 830.

If the first parameter does cross the first threshold, at block 810, the method can include setting a warning flag, at block 815. The warning flag can be a first condition for a two-factor alarm, such that the method only triggers an alert event when both the first parameter and the second parameter cross their respective thresholds. A time limit can be associated with the warning flag, such that the warning flag is only operable for a limited period of time after the first parameter crosses the first threshold, at block 820. The warning flag time limit can be, for example, 10 seconds, 1 minute, or 3 minutes, such that the two-factor alarm is only triggered if the first and second parameters cross their thresholds within a specified time-window. For example, a method with a short warning flag time limit can be appropriate to alert only when the person's posture (in this example, the second parameter) changes shortly after a spike in heart rate (in this example, the first parameter), as might be associated with the user collapsing after a cardiac event. A short warning flag time limit can be suitable to minimize false positive alarms. As an example, the method can be configured to alarm when the user is both laying down (e.g., resting) and has an elevated heart rate. In this example, a short alarm limit can be associated with the user's posture (in this example, the first parameter) such that within a short period of time after arising, the flag is cleared, at block 825, such that the method will not produce an alarm if the person arises and begins to exert herself, raising her heart rate (in this example, the second parameter).

In other embodiments, the warning flag time limit can be longer, such as 5 minutes, 10 minutes, or even 30 minutes. A long time limit can be suitable to increase the sensitivity of the method to dangerous conditions. For example, the early warning signs of an asthma attack may rouse the user from sleep and respiratory conditions may worsen over many minutes. It may be desirable to alarm if the user has an elevated rate of respiration (in this example, the second parameter) within 15 minutes of altering posture (in this example, the first parameter) from laying to sitting and/or standing.

In some embodiments, the first parameter threshold can be configured to determine whether the user is “at rest” or “active.” For example, the first parameter can be a combination of posture and change of heart rate with time. Determining whether the first parameter crosses a threshold or threshold zone, at block 810 can include detecting when the user transitions from active to resting, e.g., by detecting a transition from standing to sitting or from sitting to laying down and an associated decrease in heart rate. In such an embodiment, the warning flag can be set when the person is resting, such that changes in the second parameter that would be unusual for a resting user will generate an alert. In addition or alternatively, the warning flag can be set when the user transitions from resting to active.

Once the warning flag time limit has been reached, at block 820, the warning flag can be cleared, at block 825, and the method 800 can include continuing to monitor the first parameter, at block 805. Evaluating whether the warning flag time limit has been reached, at block 820, can include determining whether the first parameter has returned to and remained within the thresholds that caused the warning flag to be set. Alternatively, the warning flag time limit can be reached, at block 820, and the warning flag can be cleared, at block 825, if the first parameter remains at a new baseline. For example, if the user transitions from “resting” to “active,” the warning flag can be cleared without the posture parameter returning to “laying.” In such an embodiment, clearing the warning flag, at block 825, can include resetting the thresholds for the first parameter to correspond with the new baseline, e.g., a new “active” threshold can be set for the second parameter.

An alert can be generated, at block 845 if the second parameter crosses a threshold, at block 835, and the warning flag is set, at block 815. As shown, when the second parameter is determined to have crossed a threshold, at block 835, the method can include checking if the warning flag is set, at block 840. Generating the alert can include generating an audible and/or visual alert (e.g. from one of the sensor units 110 shown and described with reference to FIG. 1) and/or sending a signal to a computer device (e.g., local computer devices 115, 120 and/or the remote computer device 145). The alert can include sending past, ongoing, and/or future data associated with the first parameter and/or the second parameter, at block 850. In some embodiments, the length of the buffer (e.g., amount of historical data transmitted, at block 850) can be associated with the warning flag time limit. For example, in some embodiments, the data transmitted, at block 850, can include the threshold or threshold zone crossings of both the first parameter and the second parameter.

In some embodiments, the operations at blocks 805, 810, 815, 820, 825, 830, 835, 840, 845 or 850 may be performed using the alert event module 220 described with reference to FIGS. 2, 3 and/or 4. Nevertheless, it should be noted that the method 800 is just one implementation and that the operations of the method 800 may be rearranged or otherwise modified such that other implementations are possible.

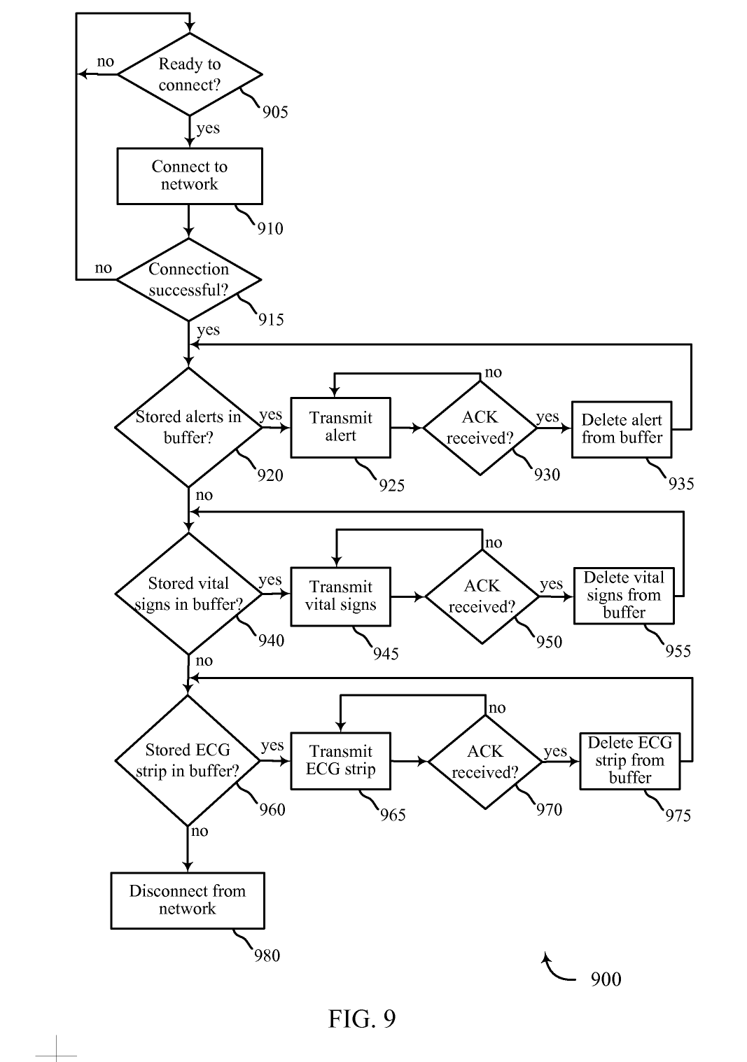

FIG. 9 is a flow chart illustrating an example of a method 900 for remote physiological monitoring, in accordance with various aspects of the present disclosure. For clarity, the method 900 is described below with reference to aspects of one or more of the sensor units 110 described with reference to FIGS. 1 and/or 4, respectively, or aspects of one or more of the apparatus 205 described with reference to FIGS. 2 and/or 3. In some examples, a sensor unit such as one of the sensor units 110 or an apparatus such as one of the apparatuses 205 may execute one or more sets of codes to control the functional elements of the sensor unit or apparatus to perform the functions described below.

Method 900 may be implemented during blocks 730 and/or 850 of methods 700, 800, respectively, and provides an example of how data to be transmitted is stored and then later transmitted if a network connection is absent. At block 905, the method 900 may check to determine whether the sensor unit is ready to connect. The sensor unit may be ready to connect if it has an alert and related data to be transmitted. If the sensor unit is not ready to connect, the method 900 simply restarts. If the sensor unit is ready to transmit, then the sensor unit attempts to connect to the network at block 910. If the connection is not successful (at block 915), the sensor unit continues to store data and attempt to connect to the network. If the network connection is successful (at block 915), the sensor unit begins to transmit various types of data that may be stored awaiting transmission.

At block 920, for example, the sensor unit determines whether any alerts are stored in its storage or buffer. If alert events are present to be transmitted, the alerts are transmitted at block 925. If transmission is successful (as indicated by the receipt at the sensor unit of an acknowledgement, at block 930), then the transmitted alerts are deleted from the buffer (at block 935) and the method 900 returns to determine whether additional alerts are stored in the buffer (at block 920). If the transmission is not successful (at block 930), the alerts are transmitted again (at block 925).

At block 940, for example, the sensor unit determines whether any data such as vital sign data is stored in its storage or buffer. If vital sign data is present to be transmitted, the vital sign data is transmitted at block 945. If transmission is successful (as indicated by the receipt at the sensor unit of an acknowledgement, at block 950), then the transmitted data is deleted from the buffer (at block 955) and the method 900 returns to determine whether additional vital sign data is stored in the buffer (at block 940). If the transmission is not successful (at block 950), the vital sign data is transmitted again (at block 945).

At block 960, for example, the sensor unit determines whether any data such as ECG strips are stored in its storage or buffer. If ECG strips are present to be transmitted, the ECG strips are transmitted at block 965. If transmission is successful (as indicated by the receipt at the sensor unit of an acknowledgement, at block 970), then the transmitted ECG strips are deleted from the buffer (at block 975) and the method 900 returns to determine whether additional ECG strips are stored in the buffer (at block 960). If the transmission is not successful (at block 970), the ECG strips are transmitted again (at block 965).

Once the alerts, vital sign data and ECG strips, for example, that are stored in the sensor unit's buffer are transmitted, the sensor unit may disconnect from the network (at block 980).

In some embodiments, the operations at blocks 905, 910, 915, 920, 925, 930, 935, 940, 945, 950, 955, 960, 965, 970, 975 or 980 may be performed using the alert event module 220 described with reference to FIGS. 2, 3 and/or 4. Nevertheless, it should be noted that the method 900 is just one implementation and that the operations of the method 900 may be rearranged or otherwise modified such that other implementations are possible.

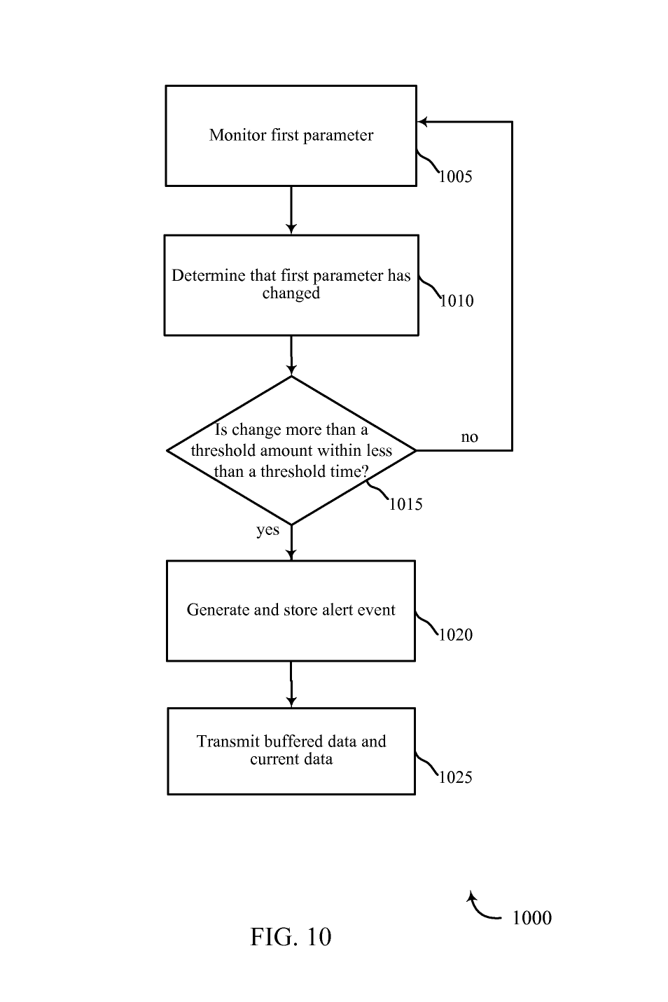

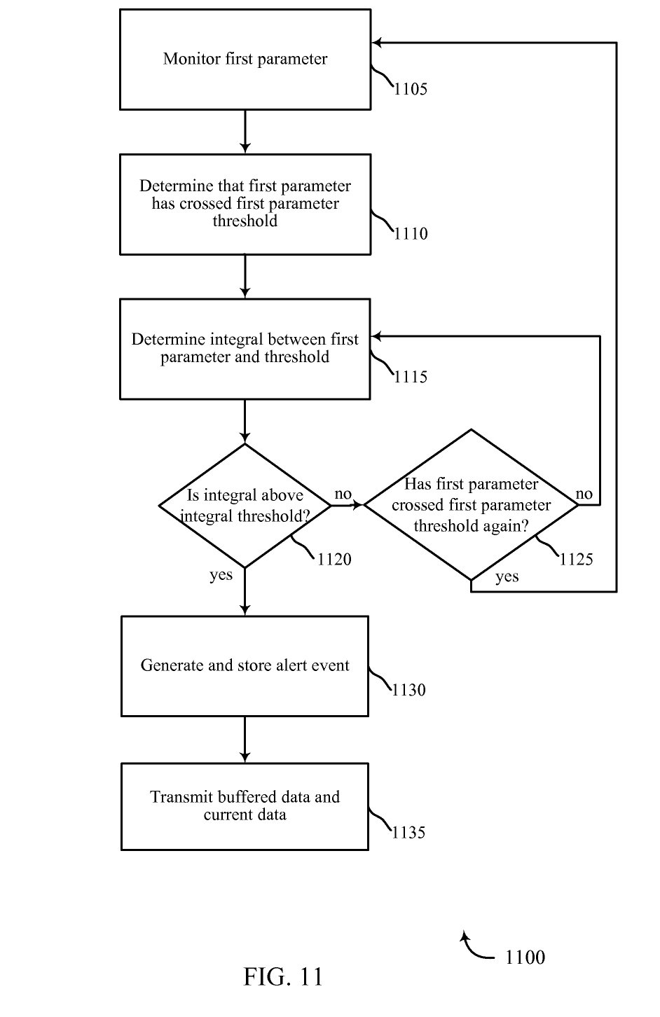

FIGS. 10 and 11 are flow charts that illustrate additional variations of how alerts may be generated and transmitted. FIG. 10 is a flow chart illustrating an example of a method 1000 for remote physiological monitoring, in accordance with various aspects of the present disclosure. For clarity, the method 1000 is described below with reference to aspects of one or more of the sensor units 110 described with reference to FIGS. 1 and/or 4, respectively, or aspects of one or more of the apparatus 205 described with reference to FIGS. 2 and/or 3. In some examples, a sensor unit such as one of the sensor units 110 or an apparatus such as one of the apparatuses 205 may execute one or more sets of codes to control the functional elements of the sensor unit or apparatus to perform the functions described below.

At block 1005, method 1000 includes monitoring a first parameter type, such as a heart rate. At block 1010, a determination is made that the first parameter has changed in value. Thus, instead of determining whether a parameter has crossed a threshold or threshold zone, method 1000 may be used to determine whether the change in a parameter's value within a period of time is in excess of a threshold amount. Accordingly, at block 1015, a determination is made whether the change in the monitored parameter has been sufficiently quick to warrant generation of an alert event. If the change has been gradual (meaning that the change occurred over a time period that was greater than a predetermined amount of time), or if the change itself was not more than a threshold amount, then an alert is not triggered and the method 1000 returns to block 1005. On the other hand, if the change is of a sufficient amount within a short enough period of time, then the method 1000 continues to block 1020 where an alert event is generated and stored. At block 1025, the alert event, along with associated data buffered and current data, is transmitted.

FIG. 11 is a flow chart illustrating an example of a method 1100 for remote physiological monitoring, in accordance with various aspects of the present disclosure. For clarity, the method 1100 is described below with reference to aspects of one or more of the sensor units 110 described with reference to FIGS. 1 and/or 4, respectively, or aspects of one or more of the apparatus 205 described with reference to FIGS. 2 and/or 3. In some examples, a sensor unit such as one of the sensor units 110 or an apparatus such as one of the apparatuses 205 may execute one or more sets of codes to control the functional elements of the sensor unit or apparatus to perform the functions described below.

At block 1105, method 1100 includes monitoring a first parameter type, such as a heart rate. At block 1110, a determination is made that the first parameter has crossed a first parameter threshold value. However, instead of triggering an alert event based on merely the crossing of the first parameter threshold, the method 1100 evaluates the integral between the monitored parameter and the first parameter threshold level to determine if the integral (i.e., the area between the curves) is greater than an integral threshold. Accordingly, at block 1115, the integral is determined between the first parameter values and the first parameter threshold. At block 1120, a determination is made whether the integral is above an integral threshold. If it is not, another determination is made whether the monitored first parameter has crossed the first parameter threshold again (meaning that the monitored parameter is no longer in a region of concern). If the monitored parameter has crossed the first parameter threshold again, the method 1100 begins again (at block 1105). If not, then method 1100 continues to evaluate the integral between the first parameter and the first parameter threshold, at block 1115. Once the determined integral is larger than an integral threshold (at block 1120), the method 1100 continues to block 1130 where an alert event is generated and stored. At block 1135, the alert event, along with associated data buffered and current data, is transmitted.

In some embodiments, the operations at blocks 1005, 1010, 1015, 1020, 1025, 1105, 1110, 1115, 1120, 1125, 1130 or 1135 may be performed using the alert event module 220 described with reference to FIGS. 2, 3 and/or 4. Nevertheless, it should be noted that the methods 1000 and 1100 are just implementations and that the operations of the methods 1000 and 1100 may be rearranged or otherwise modified such that other implementations are possible.

While various embodiments have been described above, it should be understood that they have been presented by way of example only, and not limitation. For example, although FIG. 7 has been described with reference to setting a heart rate threshold based on a posture type, in other embodiments, a threshold for any other suitable physiological parameter can be set based on any suitable parameter. For example, thresholds for respiration rate, body temperature, posture, perspiration, etc. can be set based on heart rate, respiration, body temperature, posture, perspiration, ambient temperature, altitude, atmospheric pressure, pollen count, global positioning system location, etc.

Although some embodiments described herein describe one-sided thresholds, in other embodiments, parameters can have high and low thresholds. In addition, although monitoring and alerting based on two factors are described, in other embodiments, any number of parameters can be monitored and alerting can be based on two factors crossing thresholds, three factors crossing thresholds, and/or any other suitable alerting scheme.

Where schematics and/or embodiments described above indicate certain components arranged in certain orientations or positions, the arrangement of components may be modified. While the embodiments have been particularly shown and described, it will be understood that various changes in form and details may be made.

Although various embodiments have been described as having particular features and/or combinations of components, other embodiments are possible having a combination of any features and/or components from any of embodiments as discussed above. For example, although transmitting physiologic data is shown and described as occurring in response to a parameter crossing a threshold, in other embodiments, the sensor unit can send data continuously, at the request of the user, at the request of a remote health care worker, at scheduled times, and/or when data connections to a network are available.

Although some embodiments described herein refer to physiological parameters compared against thresholds, in other embodiments, a function of a physiological parameter can be compared against a threshold. For example, in some embodiments instead of, or in addition to, determining whether a heart rate crosses a heart rate threshold, the time derivative of the heart rate (i.e., the rate of change of the heart rate) can be compared against a heart rate change threshold. In some embodiments other mathematical and/or statistical combinations of physiological parameters can be compared against complex thresholds. For example, a weighted product of heart rate and respiratory rate can be compared against an appropriate threshold. Warning flags and/or alerts can be triggered by other appropriate combinations, subtractions, divisions, integrals, derivatives, etc. of physiological parameters. In some embodiments, thresholds can be calculated based on the derivative of the parameter with respect to time and/or any other mathematical function and/or combination of functions, including, but not limited to integrals, statistical measures, or chaotic characterizations.

In some embodiments, monitoring a parameter can include evaluating parameter measurement confidence. Determining whether a parameter crosses a threshold can include determining whether the parameter crosses a threshold zone, where a threshold zone may include a threshold and an area bounding the threshold. Determining whether a parameter crosses a threshold can include determining whether a high-confidence signal exceeded the threshold. For example, if a noisy signal repeatedly crosses a threshold, there can be a low confidence that the threshold crossing can be attributed to the monitored parameter. Similarly, if the signal received from a sensor indicates that a parameter is behaving in a way that is not physically possible, there can be a low confidence that the signal accurately reflects the parameter it is intended to represent. In some embodiments, setting a warning flag and/or generating an alert can include verifying that the parameter crosses the threshold with a high confidence. Measuring and/or verifying the confidence of the signal before setting a warning flag or generating an alert can reduce false positives and/or false reporting.

The above description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

As an example, while the above description has specifically described the monitoring of physiological parameters, other types of parameters may also be monitored. These may include physical or environmental parameters.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration. A processor may in some cases be in electronic communication with a memory, where the memory stores instructions that are executable by the processor.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items indicates a disjunctive list such that, for example, a list of “at least one of A, B, or C” means A or B or C or AB or AC or BC or ABC (i.e., A and B and C).

A computer program product or computer-readable medium both include a computer-readable storage medium and communication medium, including any mediums that facilitates transfer of a computer program from one place to another. A storage medium may be any medium that can be accessed by a general purpose or special purpose computer. By way of example, and not limitation, computer-readable medium can comprise RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote light source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

1. A method of monitoring physiological parameters, comprising:
monitoring, using one or more sensors at a person, first and second physiological parameters of the person;
determining, at the one or more sensors, that at least one of the first and second physiological parameters has crossed a threshold;
generating, at the one or more sensors, an alert event based on the crossed thresholds; and
transmitting the alert event to a computing device that is separate from the one or more sensors.

2. The method of claim 1, wherein the monitoring of first and second physiological parameters is performed at first and second frequencies, respectively, the method further comprising:
transmitting data representing the first and second physiological parameters at a third frequency.

3. The method of claim 2, wherein the third frequency is less than either the first or second frequencies.

4. The method of claim 2, further comprising:
decreasing the third frequency after an initial operating period of the one or more sensors.

5. The method of claim 1, further comprising:
transmitting data representing the first and second physiological parameters, wherein the data includes data collected before the generation of the alert event and data collected after the generation of the alert event.

6. The method of claim 1, further comprising:
remotely updating the threshold.

7. The method of claim 1, wherein data representing the second physiological parameter is contextual data for the data representing the first physiological parameter.

8. The method of claim 7, wherein the generating of the alert event further comprises:
evaluating the data representing the first physiological parameter in view of the contextual data, wherein the alert event relates to the first physiological parameter.

9. The method of claim 1, wherein the generating of the alert event is based on only one of the first and second physiological parameters crossing a threshold.

10. The method of claim 1, wherein the generating of the alert event is based on both of the first and second physiological parameters crossing a threshold.

11. The method of claim 1, wherein the generating of the alert event is based on a differential between values of at least one of the first and second physiological parameters crossing a threshold during a predetermined time period.

12. The method of claim 1, wherein the generating of the alert event is based on at least one of the first and second physiological parameters crossing a threshold for a predetermined time period.

13. The method of claim 1, wherein the generating of the alert event is based on a value of an integral between at least one of the first and second physiological parameters and a corresponding threshold.

14. The method of claim 1, wherein the alert event is transmitted to the computing device via a network.

15. The method of claim 14, wherein the network is a personal area network or a local area network.

16. The method of claim 14, further comprising:
determining whether the network is available for transmission.

17. The method of claim 16, further comprising:
storing the alert event for later transmission if the network is not available for transmission.

18. The method of claim 1, further comprising:
transmitting, with the alert event, data representing the first and second physiological parameters.

19. A physiological monitoring device, comprising:
one or more sensors;
at least one processor configured to:
receive data from the one or more sensors, the data representing first and second physiological parameters of a person,
determine that at least one of the first and second physiological parameters has crossed a threshold, and
generate an alert event based on the crossed thresholds; and
a transmitter for transmitting the alert event to a computing device that is separate from the physiological monitoring device.

20. A computer program product, comprising:
a non-transitory computer-readable medium having non-transitory program code recorded thereon, the non-transitory program code comprising:
program code to monitor, using one or more sensors at a person, first and second physiological parameters of the person;
program code to determine, at the one or more sensors, that at least one of the first and second physiological parameters has crossed a threshold;
program code to generate, at the one or more sensors, an alert event based on the crossed thresholds; and
program code to transmit the alert event to a computing device that is separate from the one or more sensors.
